(19) United States
(12) Patent Application Publication
(10) Pub. No.: US 2008/0281635 A1
(43) Pub. Date: Nov. 13, 2008

(54) METHOD OF ADMINISTERING A BENEFICIARY MEDICAL PROCEDURE

(76) Inventors: Dinesh J. Martis, Loveland, OH (US); Frederick M. Oehler, Goshen, OH (US); Edward S. Biggins, Cincinnati, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/120,479

(22) Filed: May 14, 2008

Related U.S. Application Data
(63) Continuation-in-part of application No. 10/959,660, filed on Oct. 6, 2004.
Application No. 10/959,660 is a continuation-in-part of application No. 10/970,898, filed on Oct. 21, 2004.
(60) Provisional application No. 60/917,673, filed on May 14, 2007.
(60) Provisional application No. 60/917,674, filed on May 14, 2007.
(60) Provisional application No. 60/917,922, filed on May 14, 2007.
(60) Provisional application No. 60/917,924, filed on May 14, 2007.
(60) Provisional application No. 60/917,925, filed on May 14, 2007.
(60) Provisional application No. 60/917,928, filed on May 14, 2007.
(60) Provisional application No. 60/917,929, filed on May 14, 2007.
(60) Provisional application No. 60/917,931, filed on May 14, 2007.

(51) Int. Cl. G06Q 50/00

(52) U.S. Cl. 705/2

(57) ABSTRACT

A beneficiary medical procedure administration process is disclosed. The process includes entering a test administrator identity into a testing device. The testing device is also configured to take a biometric sample of the test administrator. A biometric sample may also be taken of the beneficiary. Such a scenario contemplates that the beneficiary may conduct the procedure without the presence of the test administrator during the entire procedure.

### RELATED APPLICATIONS

This application claims the benefit of priority to U.S. Provisional Application Ser. Nos. 60/917,673, 60/917,674, 60/917,922, 60/917,924, 60/917,925, 60/917,627, 60/917,928, 60/917,929, and 60/917,931, filed May 14, 2007, and is a continuation-in-part of U.S. patent application Ser. No. 10/959,660, filed on Oct. 6, 2004, and U.S. patent application Ser. No. 10/970,898, filed on Oct. 21, 2004, all of which are incorporated herein by reference.

### FIELD OF THE INVENTION

The present invention relates generally to a method of administering a beneficiary medical procedure, and more specifically relates to a method of verifying a test administrator is authorized to commence a medical procedure.

### BACKGROUND OF THE INVENTION

In the healthcare industry, tests are administered for a variety of reasons such as classifying a patient with a certain condition as well as to qualifying a patient for a certain treatment. Such a test may be administered by a physician, but often is administered by a technician or other healthcare personnel, i.e. a registered nurse, etc. The technician may be under the employment of a hospital, physician's office or other healthcare facility that administers the procedure. In the alternative, the technician may be under the employment of a third party that has an interest in servicing the potential patient. After such a test is administered, a physician typically reviews the results of the test and may issue a prescription or direct further steps or procedures.

The following is one example of how a physician visit may result in oxygen therapy for a patient. A patient or beneficiary visits a physician, complaining that he/she is experiencing shortness of breath or some other oxygen-related ailment. Based on the physician's observations, the physician may prescribe a pulse oximetry test that could be utilized to determine if the patient is in need of oxygen treatment. If the pulse oximetry test shows that the patient is in need of oxygen treatment, the physician will then prescribe oxygen treatment for the patient.

It is important to affirm that a pulse oximetry test is properly performed and conducted by a properly certified caregiver. Accordingly, a system or method that provides safeguards is desirable. A patient testing system and other related methods have been conceived and disclosed in U.S. Provisional Patent Applications Nos. 60/917,673, 60/917,674, 60/917,922, 60/917,924, 60/917,925, 60/917,627, 60/917,928, 60/917,929, and 60/917,931, as well as in U.S. patent application Ser. Nos. 10/959,660, 10/970,898. Such patent applications are incorporated by reference herein, and relate to a patient testing system and/or methods of assisting in the prevention of test fraud and facilitating the collection of test data.

### SUMMARY OF THE INVENTION

The present invention relates to one or more of the following features, elements or combinations thereof. A method of administering a beneficiary medical procedure includes entering test administrator data into a testing device. The testing device can be used to take a biometric sample of the test administrator and also to take a biometric sample of the beneficiary. The testing device can be left with the beneficiary who can self-administer the medical procedure. Under such a scenario, the beneficiary conducts the procedure while the testing device records and stores the results.

### BRIEF DESCRIPTION OF THE DRAWINGS

FIG. 1 is a flow diagram that illustrates a disclosed method of administering a beneficiary medical procedure.

### DETAILED DESCRIPTION OF EMBODIMENTS OF THE INVENTION

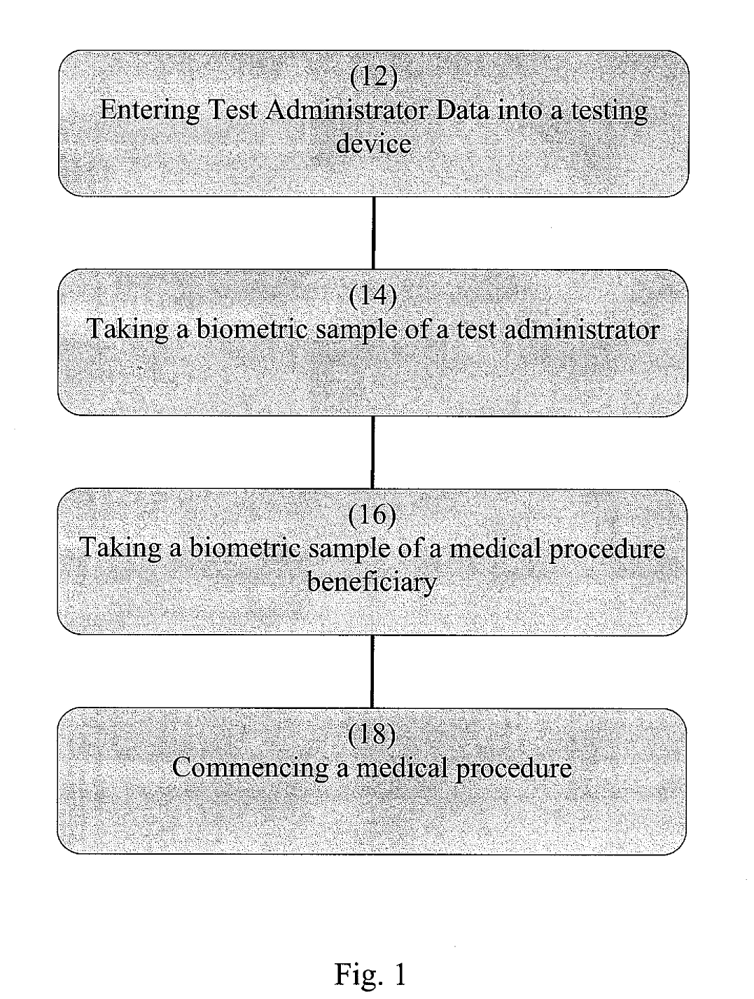

A method 10 of administering a beneficiary medical procedure is set forth generally in FIG. 1. According to one disclosed embodiment, a test administrator travels with a testing device to a location remote from a medical facility—i.e. a home of beneficiary—in order to administer a medical procedure. In order to initiate the procedure, the test administrator illustratively enters 12 test administrator data into the testing device. The test administrator data may include a test administrator name, date of birth, mobile phone number, test administrator identifier, test administrator employment start date, driver license number, and/or clinical license number. The test administrator identifier is illustratively a unique alphanumeric string assigned to the test administrator, but it is appreciated that the test administrator identifier can be any identification arrangement that enables the testing device to discern the identity of the test administrator that is attempting to access the testing device. The test administrator identifier may be assigned by a testing entity, or by any other third party or governmental agency. It is also possible that the testing device is configured to include a scanner that can read the test administrator's driver license or clinical license.

A biometric sample can also be taken 14 from the test administrator to confirm the identity of the test administrator. In one embodiment, the biometric sample could be the test administrator's fingerprint; however, it will also be appreciated that the biometric sample may be the test administrator's pulse, a retinal scan, voice recognition, facial recognition, pulse oximetry, a fingerprint, a photograph, or any other characteristic of a human body. In one embodiment, the test administrator may record his/her fingerprint while simultaneously placing a probe on his/her ear and utilizing the testing device to take a photograph of the test administrator. Such an embodiment not only confirms the identity of the test administrator via fingerprint, but also via the photograph of the test administrator. Furthermore, the ear probe could be configured to display a unique identifier (i.e. a randomly generated alphanumeric identifier) that can be included in the photograph to further confirm the identity, time, and/or presence of the test administrator and testing device.

A test administrator may also enter beneficiary data into the testing device. Such beneficiary data may comprise a beneficiary identifier and a prescription identifier. The beneficiary identifier or prescription identifier may comprise an identification (i.e. an alphanumeric string) that enables the testing device to discern the identity of the beneficiary as well as the associated prescription. However, it is also contemplated that such data will already be entered into the testing device such that upon authorization of the test administrator, the prescribed test may commence. The testing device may be configured to have an internal processor that facilitates the disclosed steps.

The testing device location may also be identified. Identifying the location of the testing device can be done to help prevent fraud. Securing the location could be done through use of global positioning system integrated into the testing device, thereby revealing whether the testing device is located at the designated test location—i.e. the beneficiary's home. However, it should be appreciated that other means of identifying the location are available, including the use of cellular phone location technologies.

The test administrator can then initiate a biometric sample of the beneficiary, as set forth in step 16. The types of biometric samples are set forth above. In one embodiment, the test administrator takes a biometric sample by placing a finger probe on the finger of the beneficiary whereby the finger probe records the heart rate and/or the fingerprint of the beneficiary and sends such information to the testing device. The testing device may also have an ear probe or alternative second probe that could be configured to also be used to take a second biometric sample of the beneficiary—i.e. the pulse at the ear of the beneficiary. The probe may also be configured to display a unique identifier (i.e. a randomly generated alphanumeric identifier), such that a photograph taken of the probe and beneficiary would display this unique identifier.

It is contemplated that by taking two biometric samples, the two samples can be compared for further confirmation of the identity of the beneficiary. Moreover, a photograph can be taken that would show the probe (and unique identifier) being worn by the beneficiary. The photograph can be used as evidence that the correct person—the beneficiary—was not only wearing the finger probe, but also was wearing the second probe and was photographed doing so. This information would also be used to confirm that the same beneficiary wore the finger probe for the entire test, rather than removing it and placing it on someone else's finger.

The beneficiary's identification, such as a driver's license, may also be scanned if the testing device is configured to include a scanner. The beneficiary's signature can also be recorded in order to certify data accuracy and validity.

At any or several points during the above procedures, an authorization procedure may be carried out. The authorization may consist of the testing device communicating with a central database in order to confirm the identity of the test administrator and/or the identity of the beneficiary. The location of the testing device may also be confirmed, as set forth above. If any of the required data can not be confirmed, the testing device may be configured to reject the data and request reentry, or to even conclude the test. Such a communication may be made via wireless phone, internet, or even standard phone line. The testing device may be equipped with its own communication system, or may be configured to be plugged in to a communication system present at the testing site/beneficiary's home.

As an alternative, the testing device may be configured to record all of the data and withhold it for confirmation at a later point—i.e. when the testing device is returned to the testing entity.

As set forth in step 118, a beneficiary may then commence the medical procedure using the testing device. It is contemplated that the test administrator is able to leave the testing device in the possession of the beneficiary, enabling the beneficiary to conduct the procedure on his/her own. At a time convenient for the beneficiary, the beneficiary may place the appropriate probes for the procedure on him/herself and power on the device on his/her own.

The testing device may be configured to record the results and conduct continuous/random beneficiary biometric sampling during the procedure. Once completed, the beneficiary may power off the device and disconnect the probes. The testing device may also be configured to notify the testing entity when the procedure is completed.

While the disclosure is susceptible to various modifications and alternative forms, specific exemplary embodiments thereof have been shown by way of example in the drawings and have herein been described in detail. It should be understood, however, that there is not intent to limit the disclosure to the particular forms disclosed, but on the contrary, the intention is to cover all modifications, equivalents, and alternatives falling within the spirit and scope of the disclosure as defined by the appended claims.

There is a plurality of advantages of the present invention arising from the various features of the method of administering a beneficiary medical procedure described herein. It will be noted that alternative embodiments of the method herein disclosed may not include all of the features described yet still benefit from at least some of the advantages of such features. Those of ordinary skill in the art may readily devise their own implementations of a method of administering a beneficiary medical procedure that incorporate one or more of the features of the present invention and fall within the spirit and scope of the present invention as defined by the appended claims.

What is claimed is:

1. A method of administering a medical procedure, the method comprising the steps of
entering test administrator data into a testing device,
taking a biometric sample of the test administrator,
taking a biometric sample of a medical procedure beneficiary, and commencing a medical procedure,
wherein the commencing step comprises the steps of
placing a testing device sensor on the beneficiary and activating the testing device,
recording the medical procedure results, and
removing the testing device sensor from the beneficiary and deactivating the testing device.

2. The method of claim 1, wherein the test administrator data comprises at least one from the group consisting of a test administrator name, date of birth, mobile phone number, test administrator identifier, test administrator employment start date, driver license number, and clinical license number.

3. The method of claim 2, wherein the test administrator identifier is a unique alphanumeric string generated by a processor.

4. The method of claim 2, wherein at least one of the clinical license number and the driver license number are scanned using a scanner incorporated with the testing device.

5. The method of claim 1, wherein the biometric sample of the test administrator comprises at least one selected from the group consisting of a retinal scan, a pulse, voice recognition, facial recognition, pulse oximetry, a fingerprint, and a photograph.

6. The method of claim 1, wherein the biometric sample of the beneficiary comprises at least one selected from the group consisting of a retinal scan, a pulse, voice recognition, facial recognition, pulse oximetry, a fingerprint, and a photograph.

7. The method of claim 1, further comprising the step of conducting a background check of the test administrator.

8. The method of claim 1, further comprising the step of confirming a clinical licensure status of the test administrator.

9. The method of claim 1, further comprising the step of authorizing the commencing step upon reviewing at least one of the test administrator biometric sample and the beneficiary biometric sample.

10. The method of claim 1, further comprising the step of recording at least one of the test administrator biometric sample and the beneficiary biometric sample for subsequent review.

11. A method of administering a medical procedure, the method comprising the steps of
entering test administrator data into a testing device,
taking a biometric sample of the test administrator,
authorizing the test administrator based on at least one of the test administrator data and the biometric sample of the test administrator,
taking a biometric sample of a medical procedure beneficiary, and commencing a medical procedure.

12. The method of claim 11, wherein the test administrator data comprises at least one from the group consisting of a test administrator name, date of birth, mobile phone number, test administrator identifier, test administrator employment start date, driver license number, and clinical license number.

13. The method of claim 12, wherein the test administrator identifier is a unique alphanumeric string generated by a processor.

14. The method of claim 12, wherein at least one of the clinical license number and the driver license number are scanned using a scanner incorporated with the testing device.

15. The method of claim 11, wherein the biometric sample of the test administrator comprises at least one selected from the group consisting of a retinal scan, a pulse, voice recognition, facial recognition, pulse oximetry, a fingerprint, and a photograph.

16. The method of claim 11, wherein the biometric sample of the beneficiary comprises at least one selected from the group consisting of a retinal scan, a pulse, voice recognition, facial recognition, pulse oximetry, a fingerprint, and a photograph.

17. The method of claim 11, wherein the authorizing step further comprises conducting a background check of the test administrator.

18. The method of claim 11, wherein the authorizing step further comprises confirming a clinical licensure status of the test administrator.

19. The method of claim 18, wherein the confirming step comprises cross-checking a clinical license number against a database of clinical licensure numbers.

20. A method of administering a medical procedure, the method comprising the steps of
entering test administrator data into a testing device,
taking a biometric sample of the test administrator,
taking a biometric sample of a medical procedure beneficiary, and commencing a medical procedure.
